(19) United States
(12) Patent Application Publication
(10) Pub. No.: US 2003/0229619 A1
(43) Pub. Date: Dec. 11, 2003

(54) Image storing apparatus and image transfer system

(76) Inventors: Hitomi Kinoshita, Nakama (JP); Fumio Hirano, Onojo (JP); Kiyoshi Enjouji, Sasaguri (JP); Yasuyuki Numata, Kasuga (JP)

Correspondence Address: STEVENS, DAVIS, MILLER & MOSHER, LLP., Suite 850, 1615 L Street, N.W., Washington, DC, 20036, US

(21) Appl. No.: 10/453,499

(22) Filed: Jun. 4, 2003

(30) Foreign Application Priority Data
Jun. 6, 2002 (JP) 2002-165575

(51) Int. Cl. G06F 7/00

(52) U.S. Cl. 707/1

(57) ABSTRACT

An image storing apparatus includes receiving means for receiving information including image data and the management information thereof, storing means for storing the image data and the management information thereof, display means for displaying the image data on a basis of the management information in each groups wherein the apparatus includes detecting means for detecting the image data and the management information in the received information by the receiving means, and control means for controlling the display means to display the image data on a basis of the management information when the detecting means detects both the image data and the management information in the information received by the receiving means.

### BACKGROUND OF THE INVENTION

The present invention relates to an image storing apparatus and image transfer system.

In recent years, digital cameras have been spread rapidly in several countries.

Pictures photographed by a digital camera can be developed more easily than pictures photographed by an ordinary camera using a film. Also, a picture may be edited to craft a greeting card, etc., and may be published on an internet web.

For example, since a personal computer is required in order to display a digital image taken by a digital camera on a screen at home, it is very troublesome for a person who is not accustomed to manipulate a computer and who has no computer at home.

For the convenience of such persons, photostoring apparatuses and printers dedicated to digital cameras have been developed. Also, a service for publishing pictures photographed by a digital camera on the web has been spread.

### SUMMARY OF THE INVENTION

However, in order to utilize such a service, a personal computer is required and also it is required to contract with a web-provider. Further, various troublesome procedures are required such as a setting operation for an internet communication with the provider.

Furthermore, when an ordinary internet service provided by the above provider is utilized, there is a risk that photographs and private documents required to be kept in secret may be opened in public.

Therefore, it has been required to develop a technology for storing image data in secret and a technology for transmitting image data from a computer to another computer on a basis of peer to peer technique.

An object of the present invention is to provide an image storing apparatus and an image transmitting apparatus which are manipulated by a user easily.

According to an aspect of the present invention, an image storing apparatus includes:

receiving means for receiving information including image data and the management information of the image data,

storing means for storing the image data and the management information of the image data,

display means for displaying the image data on a basis of the management information of the image data in each groups,

detecting means for detecting the image data and the management information of the image data in the received information by said receiving means, and

control means for controlling said display means to display the image data on a basis of the management information of the image data when said detecting means detects both the image data and the management information of the image data in the information received by said receiving means.

### BRIEF DESCRIPTION OF THE DRAWINGS

FIG. 1 is a functional block diagram showing an image storing apparatus according to a first embodiment of the present invention;

FIG. 2 is a circuit block diagram showing the image storing apparatus according to the first embodiment of the present invention;

FIG. 3 is a flow chart indicating the processing of the image storing apparatus according to the first embodiment of the present invention;

FIG. 4 is an explanatory diagram showing a display of the image storing apparatus according to the first embodiment of the present invention;

FIG. 5 shows a data structure of an album in the first embodiment of the present invention;

FIG. 6 is a flow chart indicating the data transmitting processing of the image storing apparatus according to the first embodiment of the present invention;

FIG. 7 is a flow chart indicating the data receiving processing of the image storing apparatus according to the first embodiment of the present invention;

FIGS. 8A to 8G are explanatory diagrams showing display examples of every image exchange formats in the image storing apparatus according to the first embodiment of the present invention;

FIG. 9 is a functional block diagram showing an image storing apparatus according to a second embodiment of the present invention;

FIG. 10 is a circuit block diagram showing the image storing apparatus according to the second embodiment of the present invention;

FIG. 11 is a diagram showing a table for images in the second embodiment of the present invention;

FIG. 12 is a diagram showing an album management table in the second embodiment of the present invention;

FIG. 13 is a diagram showing a divided area of a page in the album on a display unit in the embodiment of the present invention;

FIG. 14 is a diagram showing one page of the album on the display unit in the second embodiment of the present invention;

FIG. 15 is a flow chart indicating the transmitting processing in the second embodiment of the present invention; and

FIG. 16 is a flow chart indicating the receiving processing in the second embodiment of the present invention.

### DETAILED DESCRIPTION OF THE EMBODIMENT

The embodiments of the present invention will be described with reference to the accompanying drawings.

First Embodiment

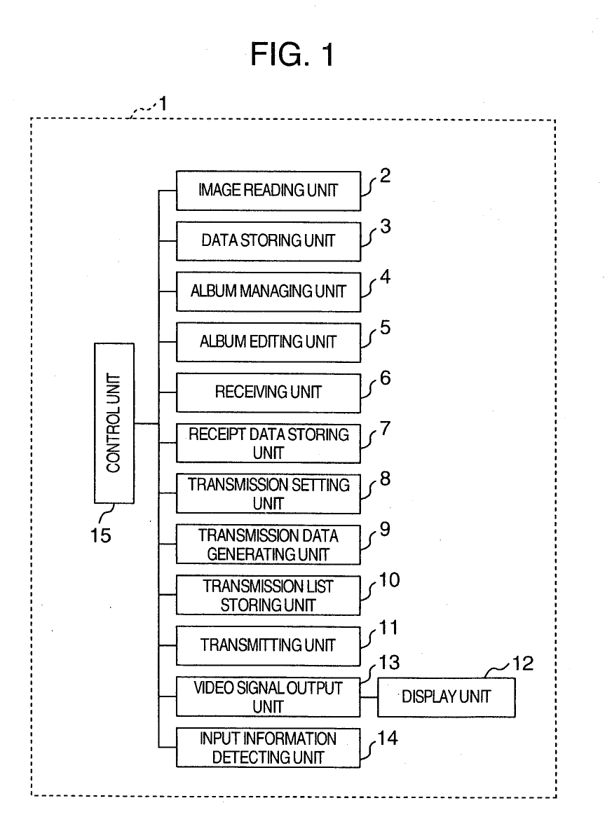

FIG. 1 is a functional block diagram showing an image storing apparatus according to the first embodiment of the present invention.

Data dealt in the image storing apparatus according to the first embodiment includes image data such as photograph data, text data and other various kinds of data.

As shown in FIG. 1, the image storing apparatus 1 includes various units as explained bellow.

An image reading unit 2 reads image data, management information of the image data, character data etc. from a memory. The memory is a storage medium such as various kinds of compact discs, memory cards each adapted to be detachable from the storing apparatus 1.

A data storing unit 3 stores image data read by the image reading unit 2. An album managing unit 4 stores the information relating to the image data such as the character data and the management data, read by the image reading unit 2.

An album editing unit 5, as to the information stored in the album managing unit 4, shifts the image data between albums, deletes and copies the album itself and also deletes and copies the image data, the character image and the management data within the album itself.

The album managing unit 4 manages the read image data in a form of “album information”. In this respect, the album information includes the number of albums, the number of pages which the album has, the number of images (photographs) on a single page of the album. The album information can be defined and set arbitrarily by a user.

A receiving unit 6 receives various kinds of data from an external device through a telephone line and so on. A receipt data storing unit 7 stores received image data, etc.

A transmission setting unit 8, in accordance with an instruction from a user, sets an address (destination address) to which data is transferred or sent, data transferring date/time and a format of the image to be transferred, and selects data to be transferred.

A transmission data generating unit 9 generates transmission data from the image data in order to transfer the image data etc. within the image storing apparatus 1 to another storing apparatus, on the basis of the conditions set by the transmission setting unit 8.

A transmission list storing unit 10 stores contents (conditional information) set by the transmission setting unit 8.

A transmitting unit 11 sends transmission data generated by the transmission data generating unit 9 on the basis of the conditional information thus set.

A video signal output unit 13 converts the image data, character data and so on to video signals to be displayed and outputs the video signals to a display unit 12. The video signals output from the video signal output unit 13 have a signal for displaying simultaneously the arbitrarily number of image data (photographs) in the album and signals for displaying the album information such as a name of album.

An input information detecting unit 14 detects the image data and the album management information from received transmission data. A control unit 15 controls the entirety of the apparatus 1.

If the received transmission data contains album management information, the receipt data storing unit stores the album management information, whereas if not, the receipt data storing unit 7 creates a new album and stores the received image data in the new album (to be later described).

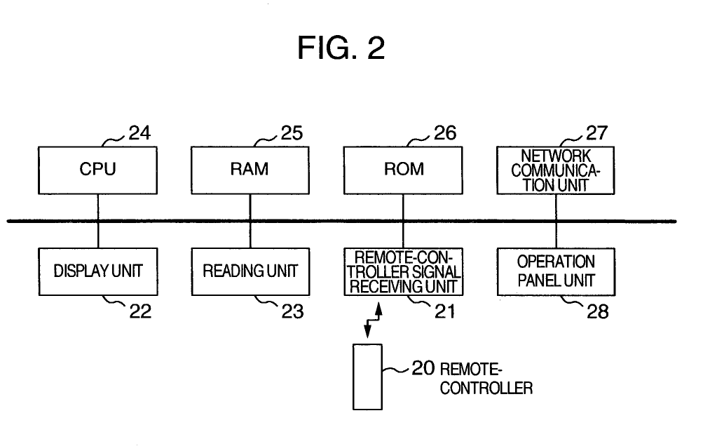

FIG. 2 is a circuit block diagram showing the hardware configuration of the image storing apparatus according to the first embodiment of the invention.

As shown in FIG. 2, the image storing apparatus includes a remote-controller signal receiving unit 21 which receives an instruction (command) from a remote-controller 20, a display unit 22 which displays video signals of image data and album information, etc. converted in the display format, a reading unit 23 which reads data from a removable storage medium such as a memory card, a central processing unit (CPU) 24 which controls the whole of the apparatus 1, a random access memory (RAM) 25, a read-only memory (ROM) 26 which stores programs to be executed by CPU 24, a network communication unit 27 transfers data to and from another image storing apparatus located at a remote site, and an operation panel unit 28 through which a user inputs an instruction or command.

With reference to FIGS. 1 and 2, a correspondence between the functional block diagram of FIG. 1 and the hardware configuration diagram of FIG. 2 will be described.

The image reading unit 2, the album managing unit 4, album editing unit 5, transmission setting unit 8, transmission data generating unit 9, video signal output unit 13, input information detecting unit 14, and control unit 15 are realized by CPU 24 which executes various programs stored in ROM 26 by exchanging data with RAM 25.

The transmission setting unit 8 corresponds to the remote-controller 20, remote-controller signal receiving unit 21 and operation panel unit 28, and performs transmission settings in accordance with the information supplied from the remote-controller signal receiving unit 21. The receiving unit 6 and transmitting unit 11 corresponding to the network communication unit 27 and perform reception/transmission of various kinds of data from/to an image storing apparatus located at a remote site. The read data storing unit 3, receipt data storing unit 7, transmission list storing unit 12 are realized by RAM 25.

Description will be given on the operation of the image storing apparatus of the embodiment constructed as above, with reference to the accompanying drawings including flow charts.

These flow charts illustrate the processes to be executed by CPU 24 (control unit 15) in accordance with the programs stored in ROM 26.

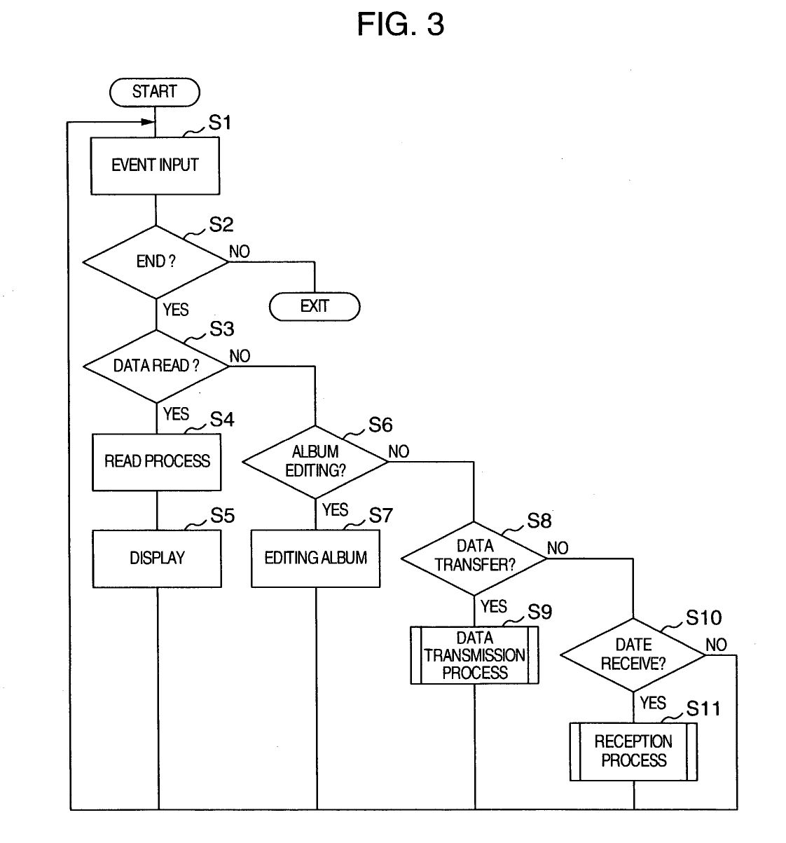

Referring to FIG. 3, at S1 (Step 1) the control unit 15 detects and analyzes an instruction from a user or an event from the receiving unit 6. An instruction from a user is sent from the remote-controller signal receiving unit 21.

There are five events to be processed: a system end, reading data (photograph data taken with a digital camera) from a memory card, editing photographs in an album, data transmission to another image storing apparatus, and a connection request (data reception) from another image storing apparatus.

At S2, the control unit 15 determines whether or not the input event is the system end. If the event is the system end, the process is terminated, whereas if not, the process proceeds to S3.

At S3, the control unit 15 determines whether or not the input event is an event of reading data from the memory card. If the event is a data read, the process proceeds to S4, whereas if not, the process proceeds to S6.

At S4, the image data (in this embodiment, a photograph image taken with a digital camera) in a memory card (not shown) is stored as a new album in the reading data storing unit 3.

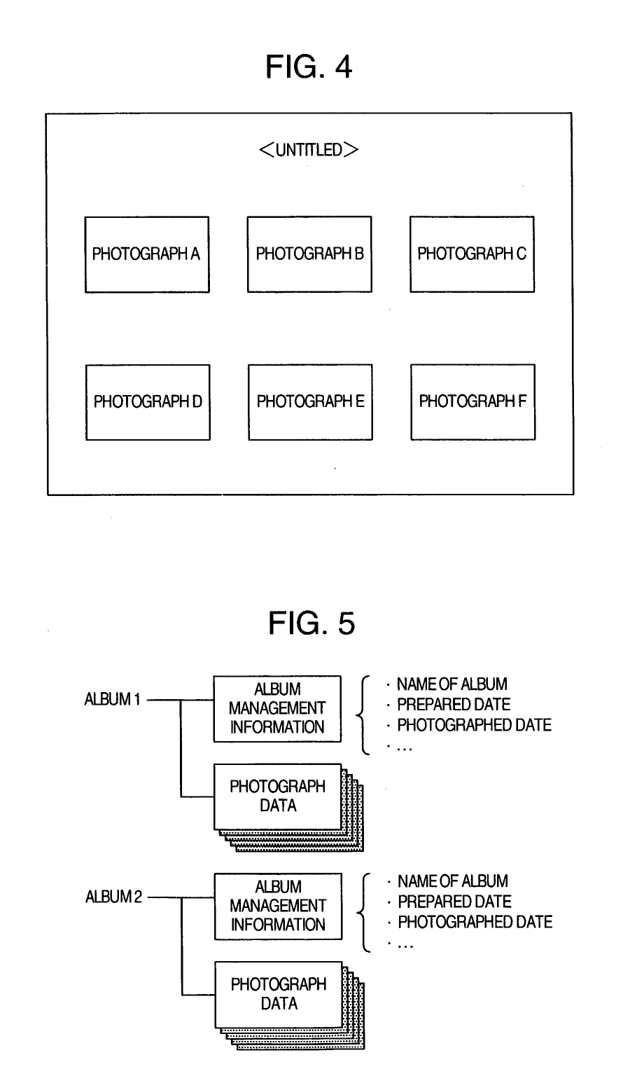

At S5, the control unit 15 makes the display unit 12 display a list of images (stored as the new album) read from the memory card to thereafter return to S1 (refer to FIG. 4).

As shown in FIG. 4, the name of the album is stored as “untitled” at the time immediately after the image read. The name can be changed to an arbitrary name in “album editing” by the album editing unit 5 to be later described.

Successively, at S6, the control unit 15 determines whether or not the input event is an event of reading an album. If the event is an event of reading an album, the process proceeds to S7, whereas if not, the process proceeds to S8.

At S7, the album editing unit 5 performs a process of editing an album.

The process of editing an album includes, for example, an album title change, an album elimination, an album division/unification, a photograph image transfer between albums, and a photograph image addition/elimination.

At S8, the control unit 15 detects whether or not the input event is an instruction of data transfer, If the event is an instruction of data transfer, the process proceeds to S9, whereas if not, the process proceeds to S10.

<Process of Transmitting Data>

Referring to FIG. 3, at Step 9, a process is executed for transmitting data to another image storing apparatus located at a remote site.

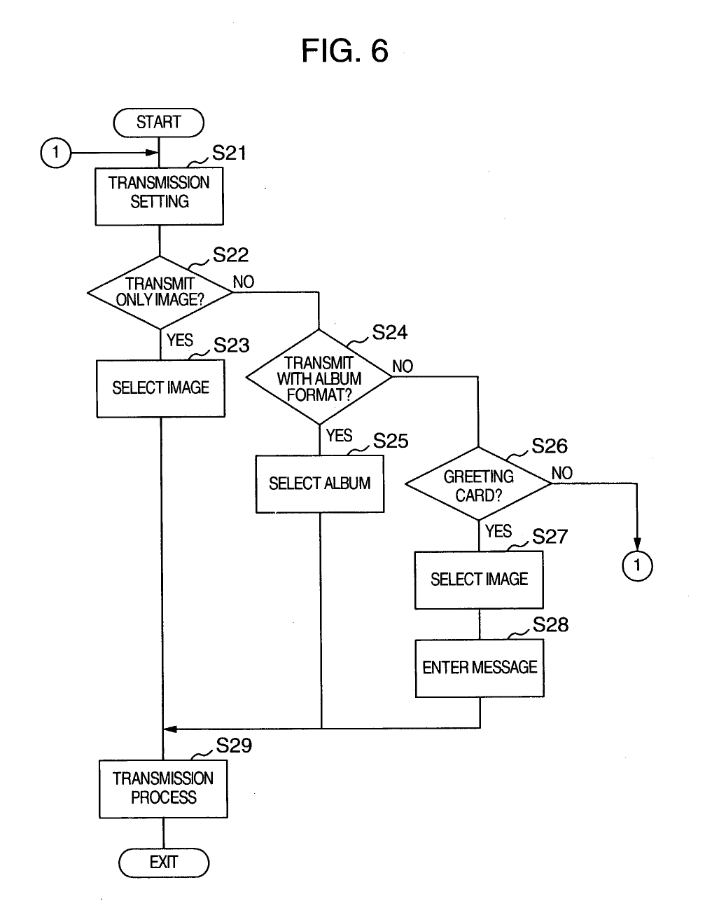

A flow of the data transmission process of the image storing apparatus of the embodiment will be described along with a flow chart shown in FIG. 6.

First, at S21, the transmission setting unit 8 sets “data transmission destination”, “transmission date and time” and “transmission format”.

In the image storing apparatus of the embodiment, it is assumed that data is transmitted via a telephone line.

The image storing apparatus 1 is coupled to a telephone line and a destination telephone number is set as the data transmission destination.

It is assumed that a plurality of transmission destinations can be set. There are three formats, “photographs only”, “album” and “greeting card”. If the greeting cart format is selected, a character message can be appended.

At S22, the control unit 15 determines whether or not the transmission format set at S21 is the “photographs only” format. If so, a user is urged to select an image or images (at S23), whereas if not, the process proceeds to S24.

At Step 24, the control unit 15 determines whether or not the transmission format set at S21 is the “album” format. If so, the user is urged to select an album (S25), whereas if not, the process proceeds to S26.

At S26, the control unit 15 determines whether or not the transmission format set at Step 21 is the “greeting card” format. If so, the user is urged to select an image (S27) and then enter a message (S28). If the transmission format set is none of the “photographs only”, “album” and “greeting card” formats, the process returns to S21 to urge the user set the format again.

At S29, the control unit 15 detects whether or not the transmission date and time were set at S21. If the transmission date and time were set, they are stored in the transmission list storing unit 10. Immediately before the transmission date and time, the transmission data generating unit 9 generates transmission data in accordance with the transmission settings set by set by the transmission setting unit 8. The transmitting unit 11 automatically transmits the transmission data stored in the transmission list storing unit 10 to the destination apparatus at the set transmission date and time.

If the transmission date and time are not set, the control unit immediately sets a connection request to the image storing apparatus at the destination, and after the establishment of a connection, the transmitting unit 11 transmit transmission data generated by the transmission data generating unit 9.

Reverting to FIG. 3, at S10, the control unit 15 detects whether or not the input event is a request for receiving data. If so, the process proceeds to S11, whereas if not, the process goes back to S1 and awaits a next event.

<Process of Receiving Data>

At Step 11, the process is executed for receiving data from an image storing apparatus located at a remote site.

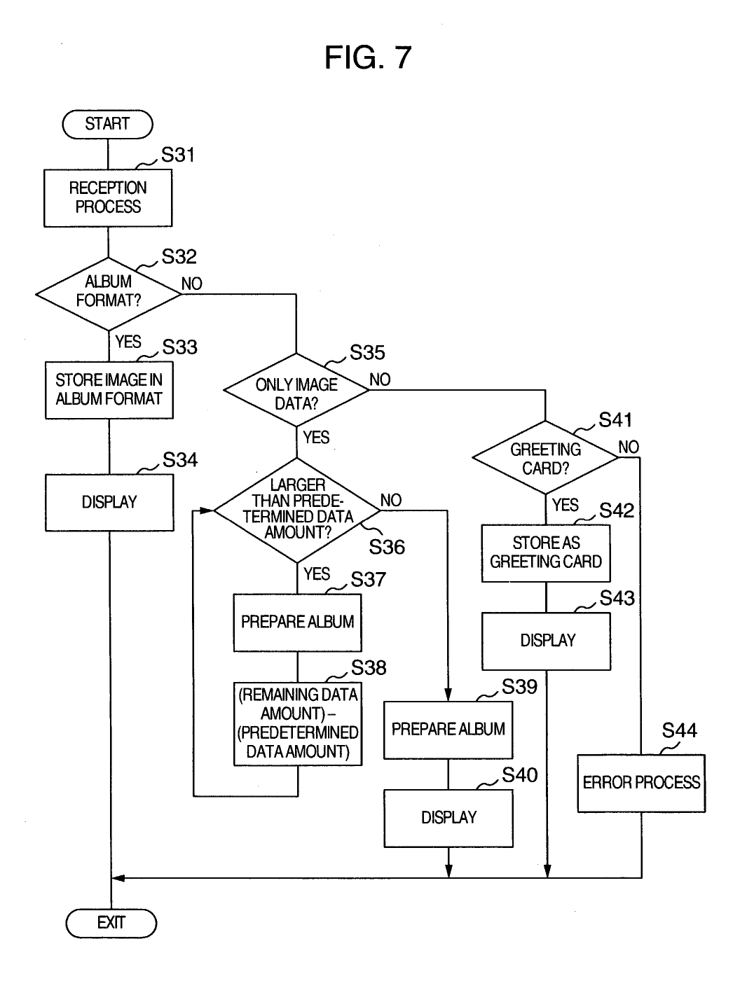

A flow of the data reception process of the image storing apparatus of the embodiment will be described along with a flow chart shown in FIG. 7.

First, at S31, the receiving unit 6 receives a connection request from another image storing apparatus located at a remote site and performs a variety of analysis processes for received data.

Successively, at S32, the control unit 15 detects whether or not the format of the received data is the “album” format. If so, the process proceeds to S33, whereas if not, the process proceeds to S35.

If the received image data is of the “album” format, the input information detecting unit 14 detects both “image data” and “management information of the image data”.

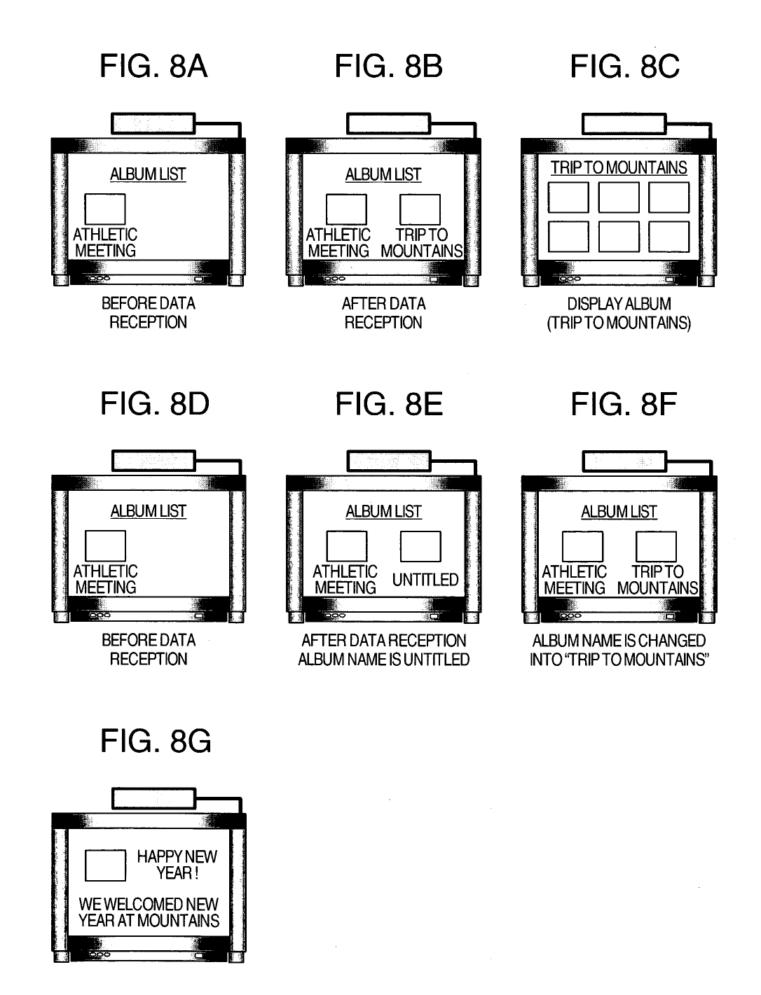

At S33, the received image data is stored in the “album format” in the album managing unit 4. Successively, at S34, the video signal output unit 13 converts the stored image data into the display format of an album list and outputs it to the display unit 12 to display it (refer to FIGS. 8A and 8B). When each received image (photograph image) is needed to be displayed, the video signal output unit 13 converts the image data into the display format of a photograph list and outputs it to the display unit 12 to display it (refer to FIG. 8C). In this respect, FIGS. 8A to 8C show an example of image data reception in the album format. FIGS. 8D to 8F show an example of data reception of only image data, and FIG. 8G shows an example of reception of a greeting card.

At S35, the input information detecting u nit 14 detects whether or not the format of the received data is the “photographs only” format. If so, the process proceeds to S36, whereas if not, the process proceeds to S41.

At S36, the control unit 15 activates the album editing unit 5 to detect whether or not the number of received photograph images is larger than a predetermined data amount (the number of photographs which can be registered in on album). If the number is larger, the process proceeds to S37, whereas if not, the process proceeds to S39.

At S37, one album is assigned to the predetermined data amount of the received image data and stored as a new album in the album managing unit 4. At S38, the predetermined data amount is subtracted from the amount of the received data to thereafter return to S36.

If the number of received photograph images can be accommodated in one album, then at S39, the corresponding image data is stored in the new album created by the album managing unit 4 and displayed on the display unit 12 (S40).

In order to display the received image data on the display unit, the video signal output unit 13 converts the image data into the display format of the album list and outputs it to the display unit 12 to display it (refer to FIGS. 8(B), (d), (e)).

Referring to 8(B) (f), the title of the album is changed from “untitled” at the time of receiving the image data to “trip in mountains” by the editing function of the album managing unit 2.

At S41, the input information detecting unit 14 detects whether or not the format of the received data is the “greeting card” format. If so, the process proceeds to S42, whereas if not, the process proceeds to S44.

If the format is the “greeting card” format, image data and character data are detected.

At S42, the received data is stored in a greeting card storage area, and at S43, the video signal output unit 13 converts the received data into the display format of a greeting card to display it on the display unit 12 (refer to FIG. 8(C)).

At S44, the display unit displays a message that the format of the received data is unknown.

As explained above, the image storing apparatus of the embodiment can establish a network connection in a form of P to P (peer to peer) without a web-server and also can exchange directly data such as digital photograph image data without the contract with an Internet provider and the setting of a computer for communication with a web-server.

Second Embodiment

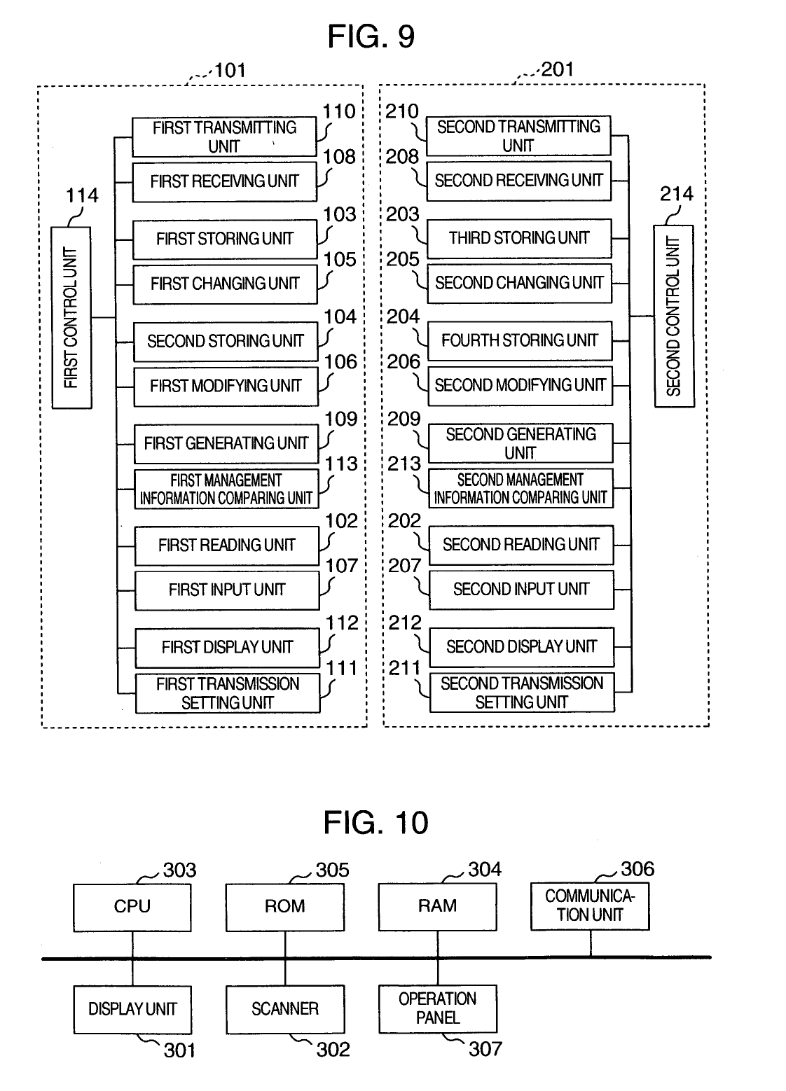

Referring to FIG. 9 through FIG. 15, the second embodiment of the invention will be described.

FIG. 9 is a functional block diagram of an image storing apparatus according to the second embodiment of the invention.

Data with which the storing apparatus of the second embodiment deals includes image data such as photograph data, and other various data such as character data.

The display format of a display unit is similar to that of the first embodiment. Also, a form of display on the display screen is the same as the form of the first embodiment. The display unit can display a plurality of albums each including a photograph or photographs or a predetermined number of photographs in one album.

First, an image storing apparatus (transmitting apparatus) 101 will be described.

Referring to FIG. 9, a first reading unit 102 reads images on a sheet of paper, a photographic film, etc. A first storing unit 103 stores image data read by the first reading unit 102. A second storing unit 104 stores character data and management information, etc. of the image data read by the first reading unit 102. A first changing unit 105 changes the image data stored in the first storing unit 103. A first modifying unit 106 transfers stored image data between albums, and deletes or copies an album itself, image data, character data, management information, etc. in an album.

In the second embodiment, the read image data is managed by “album forms”.

The album forms include “number of albums”, “number of pages in one album”, “number of photographs to be displayed in one page” and the like, and can be set or defined freely by a user.

A change in an image and a modification of management information can be performed by the modifying unit and changing unit upon an instruction by a user from the first input unit 107.

A first receiving unit 108 receives various kinds of data from the outside of the apparatus 101 through a telephone line. A first generating unit 109 generates transmission data from the received data by editing and converting the received data. A first transmitting unit 110 transmits the transmission data generated by the generating unit 109 through a telephone line.

A first transmission setting unit 111 sets image data to be transmitted, a transmission destination, transmission date and time, a transmission format, etc. in accordance with user settings. A first display unit 112 converts image data and the management information, etc. to signals having a format capable of being displayed to display them. A management information comparing unit 113 compares the received management information with the management information stored in the first storing unit 103. A first control unit 114 controls the whole of the apparatus 101.

In the second embodiment, if the management information is appended to the received image data (photograph), the image data is stored on the basis of the management information. On the other hand, if the management information is not appended, a new album is formed and the received image data is stored in the new album (as will be later described).

Next, an image storing apparatus (receiving apparatus) 201 will be described.

The receiving apparatus 201 has the structure same as that of the transmitting apparatus 101.

A third storing unit 203 corresponds to the first storing unit 103 of the apparatus 101 and a fourth storing unit 204 corresponds to the second storing unit 104.

FIG. 10 is shows a circuit block diagram showing the hardware structure of the image storing apparatus of the second embodiment.

A display unit 301 converts image data and management information, etc into a video signal and displays it. A scanner 302 scans an image to read it. A central processing unit (CPU) 303 controls the whole of the apparatus 101. A random access memory (RAM) 304 temporally stores various kinds of data and information. A read-only memory (ROM) 305 stores programs to be executed by CPU 303. A communication unit 306 is connected to a network and receives and transmits data and information from and to another apparatus located at a remote site. An operation panel 307 is used by a user to input an instruction.

The receiving apparatus 201 has the same hardware structure as above.

Description will be given on the relationship between the functional block diagram shown in FIG. 9 and the hardware structure shown in FIG. 10, respectively of this embodiment.

In FIGS. 9 and 10, the first reading unit 102, first changing unit 105, first modifying unit 106, first transmission setting unit 111, first management information comparing unit 113 and first control unit 114 are realized by CPU 303 which executes various programs stored in ROM 305 by exchanging data with RAM 304.

The operation panel 307 corresponds to the first input unit 107, and the first receiving unit 108 and first transmitting unit 110 correspond to the communication unit 306. The first and second storing units 103 and 104 are realized by RAM 304. The display unit 301 corresponds to the first display unit 112.

Next, data stored in the first and second storing units will be described.

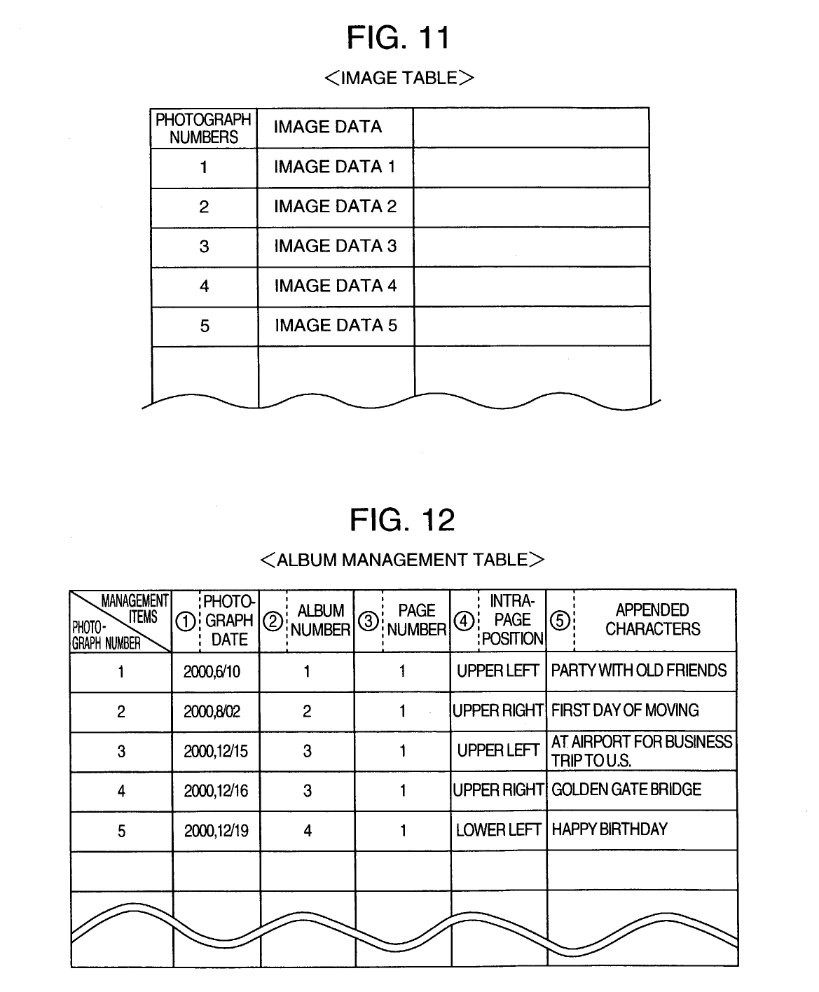

Referring to FIG. 11, the first storing unit 103 stores an image table for storing “photograph images (image data)” in correspondence with “photograph numbers).

Referring to FIG. 12, the second storing unit 104 stores an album management table for storing a plurality of management items: including “photograph number” in the leftmost column, “photograph date” in the first column (1), “album number” in the second column (2), “page number” in the third column (3), “intra-page position” in the fourth column (4) and “appended characters” in the fifth column (5).

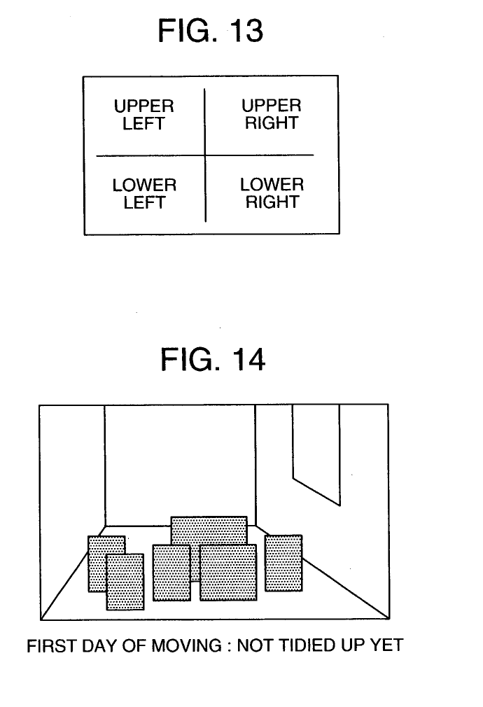

In this examples shown in FIGS. 11 and 12, the first storing unit 103 stores five photograph images, and the second storing unit 104 stores the management information of each of the five photograph images. Referring to FIG. 13, each page of the album is divided into four sections, upper left, lower left, upper right and lower right sections.

A user can change the photographs in the image table through the input unit 107. For example, if the user deletes the image having the photograph number “2”, the corresponding management information in the album management table can be deleted automatically. The user can also modify the album management table by the first revising unit 106 through the input unit 107.

For example, as shown in FIG. 14, the user can modify the characters appended to the photograph number “2” from the present comment “first day of movement” to a comment “first day of movement: not cleaned up yet”. With this modification, the modified character train is displayed on the display unit 112 as a photograph comment.

The operation of the image storing apparatus constructed as above will be explained as along with flow charts and other drawings.

<Case A>

In this Case A, the operation of the second embodiment will be explained after a new photograph and its management information were added to an album in the transmitting apparatus 101.

It is assumed that a photograph number “6” and its image data are newly added to the image table in the first storing unit 103, and that “(photograph number) 6”, “(photograph date) Dec. 25, 2000”, “(album number “5”)”, “(page number “1”), “(intra-page position upper left)” and “(appended characters silent night)” are stored as the management information in the management table in the second storing unit 104.

(1) Transmission Operation

The first generating unit 109 generates transmission information on the basis of the newly added photograph and its management information thereof. The management information is generated by adding header numbers, such as “(1) Dec. 25, 2000”, “(2) 5”, “(3) 1”, “(4) upper left” and “(5) silent night”, as shown in FIG. 12.

The fourth storing unit 204 is provided with areas for the management information corresponding to the header numbers.

The first transmitting unit 110 converts the transmission information to the signals which can be transmitted through a telephone line and transmits the signals to the receiving apparatus 201. As to the transmission signals, text data of “photograph number”, “photograph date”, “album number”, “page number”, “intra-page position” and “appended characters” are generated along with the header numbers and then bit map data of “image data” is generated, respectively in this order recited.

(2) Reception Operation

The following reception operation is automatically performed by the second control unit 214.

Referring to FIG. 16, at S60, the second receiving unit 208 of the receiving apparatus 201 receives the image data and the management information thereof. Next, the process proceeds to S63 through S61 and S62.

At S63, the newly added image is stored in the designated section of a designated page of a designated album, in accordance with the management information. In this Case A, since a new album is added, the new album is stored in the third storing unit 203 and a pair of “photograph number 6” and “photograph image data” is stored in the album.

More specifically, when the second changing unit 205 detects the photograph number in the received signals and the bit-map data following the photograph number, the second changing unit determines the bit-map data as the image data and stores the bit-map data in the third storing unit 203.

When the second receiving unit 206 detects the photograph number in the received signals and the text data following by the photograph number, the second receiving unit 206 determines the text data as management information and stores the management information in the memory area of the fourth storing unit 204 corresponding to the header numbers (1) to (5) appended to the management information.

Accordingly, the photograph number and photograph image data are stored adequately in the fourth storing unit 204.

Therefore, when a user inputs a display instruction from the second input unit 207, already registered albums and the newly added album are displayed and the photograph image is displayed in the upper left section at the first page of the album.

<Case B>

It is assumed that the same photograph image is stored in the first storing unit 103 of the transmitting apparatus 101 and the third storing unit 203 of the receiving apparatus 201, and that the same management information corresponding to the photograph is stored in the second storing unit 104 of the transmitting apparatus 101 and the fourth storing unit 204 of the receiving apparatus 201.

(1) Transmission Operation

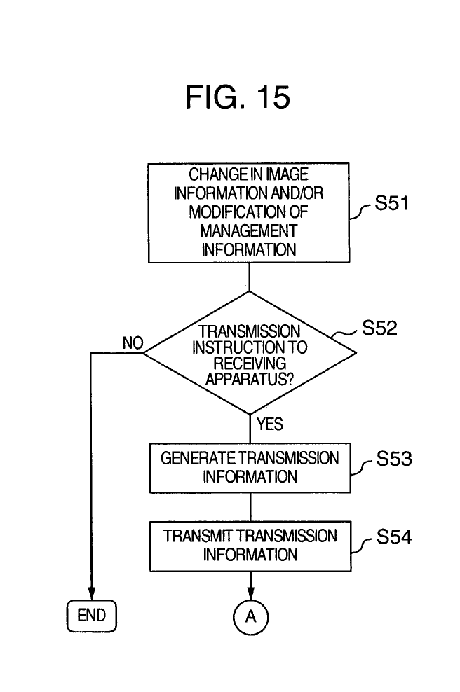

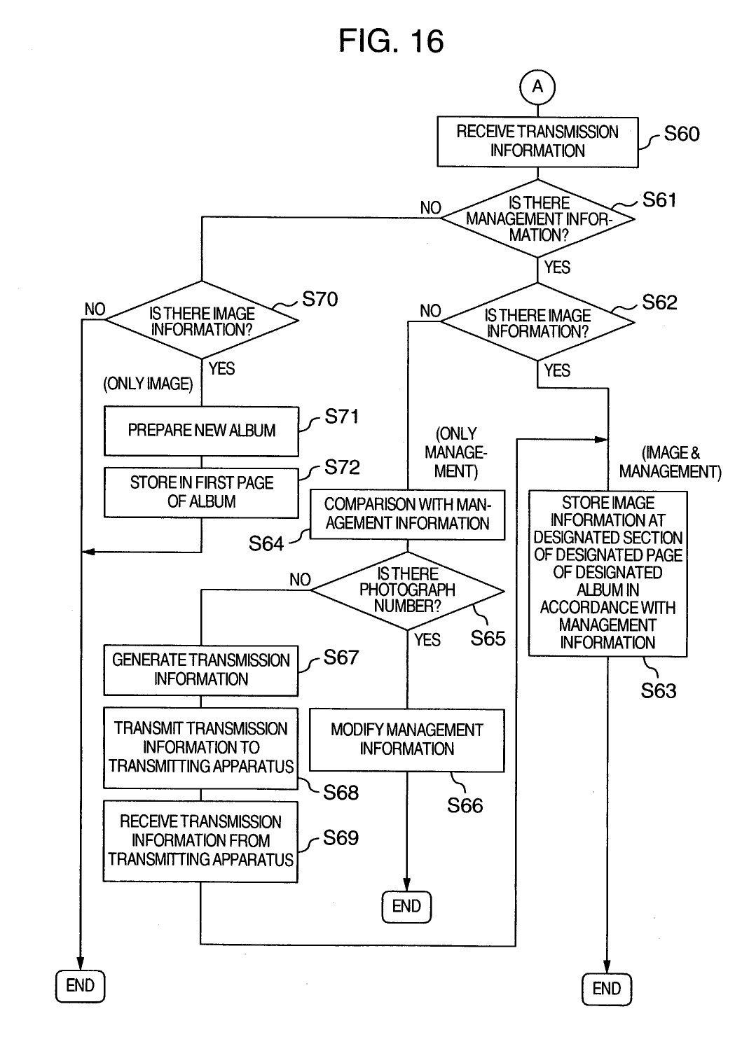

Referring to FIG. 15, after a change in the image and/or a modification of management information by a user on the side of the transmitting apparatus 101 (S51), the user enters an instruction from the first input unit 107 to transmit the change and modification to the receiving apparatus 201, at S51. At S52, when the control unit 114 detects this instruction, the process proceeds to S53.

Next, the first generating unit 109 detects the change and modification of the data and the information stored in the first and second storing units.

As explained above, in the second embodiment, if only the appended characters “first day of movement” are modified, the transmission information is generated in accordance with the “modified character train” and “photograph number”.

Accordingly, the first generating unit generates the transmission information so as to transmit “photograph number “2””, “header number (5)” and “appended characters (modified character string)” in this order.

At S54, the first transmitting unit 110 converts the transmission information generated in the above manner to the signals which can be transmitted through a telephone line and transmits the signals to the receiving apparatus 201.

(2) Reception Operation

The operation of the receiving apparatus 201 which received only management information will be described in the following.

At S60, the second receiving unit 208 receives the management information from the first transmitting unit 110 of the transmitting apparatus 101. The following reception processes are automatically executed by the second control unit 214.

At S61 and S62, the second control unit 214 detects whether the transmission information contains the management information and photograph image data.

In this case, since only the management information is contained in the transmission information, the process proceeds to S64.

At S64, the received management information is compared with the management information stored in the fourth storing unit 204. In this embodiment, it is checked whether the “photograph number “2”” in the received management information is stored in the fourth storing unit 204.

Since it is judged at S65 that “photograph number “2”” is stored in the fourth storing unit 204, the process proceeds to S66. At S66 the second modifying unit 206 overwrites the received appended characters (modified character string) in the memory area corresponding to the header number (5) in the fourth storing unit 204, in accordance with the received “header number (5)”.

<Case C>

(1) Transmission Operation

If only a new photograph image is added at the transmitting apparatus 101, the first generating unit 109 generates transmission information from only the photograph image and the first transmitting unit 110 converts the transmission information consisting of only the photograph image to the signals which can be transmitted through a telephone line and transmits the signals to the receiving apparatus 201.

(2) Reception Operation

The following reception process is automatically executed by the second control unit 214.

At S70, the second receiving unit 208 of the receiving apparatus 201 receives the transmission information from the transmitting apparatus 101.

In the Case C, the receiving process proceeds to S71 through S61 and S70 according to the decision of the second control unit 214.

At S71, the second changing unit adds a new album in the third storing unit 203. Furthermore, at Step 72, the second revising unit 206 modifies the management information in the fourth storing unit 204 so as to add the photograph image in the upper left section of the first page of the added album.

<Case D>

In the Case B, it is assumed that the apparatus 101 has the same photographs and the management information thereof as the apparatus 201 has. In the Case D, it is assumed that the photographs to be transferred from the apparatus 101 exist in the apparatus 201.

Also, in the case D, it is assumed that only the management information is transmitted to the receiving apparatus 201 from the transmitting apparatus 101. The management information includes a photograph number “2”, a header number (5), and an appended character string (modified character string).

(1) Transmission Operation

Referring to FIG. 15, after changing the photographs or modifying the management information (at S51) by a user on the side of the transmitting apparatus 101, the user instructs from the first input unit 101 to transmit the changed photographs or the modified management information to the receiving apparatus 201. At S52, the control unit 114 detects the instruction and the process proceeds to S53.

Successively, the first generating unit 109 detects a change in the photographs stored in the first storing unit and a modification of the management information in the second storing unit. For example, if the appended characters “first day of movement” for the photograph number “2” are modified, the transmission information is generated in accordance with the “photograph number”, “header number” and “modified character string”. In this case, the transmission information does not contain the image data.

The transmission information includes, therefore, the transfer information includes “2”, “(5)”, and “first day of movement: not cleaned up yet”.

As explained above, the generating unit adds “(5)” as the header number of the modified character string.

At S54, the first transmitting unit 110 converts the transmission information to the signals which can be transmitted through a telephone line and transmits the signals to the receiving apparatus 201.

(2) Reception Operation

The following reception operation is automatically performed by the first and second control units 114, 214.

In the Case D, the receiving process proceeds to S65 through S60, S61, S62 and S64, based upon a judgement of the second control unit 214.

Next, at S65, the second control unit 214 determines that there is no photograph number “2” in the photograph table and album management table in the third and fourth storing units, and the process proceeds to S67.

At S67, the second generating unit 209 generates the transmission information including the received information about the photograph number “2”.

At Step 68, the second transmitting unit 210 transmits the photograph number “2” in the transmission information generated by the second generating unit 209 to the transmitting apparatus 101.

At S69, the first receiving unit 108 receives the transmission information from the second transmitting unit 210, and the information about the photograph number “2” is transferred to the first generating unit 109. The first generating unit 109 generates transmission information in accordance with the photograph in the first storing unit 103, corresponding to the photograph number “2”, and the management information in the second storing unit 104, corresponding to the photograph number “2”.

The first transmitting unit 110 transmits the transmission information to the receiving apparatus 201.

In this embodiment, the transmitting unit transmits only the photograph data corresponding to the photograph number “2”, and the management information regarding the header numbers “(1) to (4)”.

All the management information about the photograph number “2” may be transmitted by changing the transmission settings.

On the side of the receiving apparatus 201, the process proceeds to S63 through S60, S61 and S62. The new photograph and management information thereof regarding the photograph number “2” are stored in the first and second storing units 203 and 204, respectively.

In this embodiment, if the control units 114, 214 operate upon an instruction by a user, the photograph data in the first storing unit 103, the album management table in the second storing unit 104 are transmitted to the display unit 112 and the photograph data and/or the album management table can be displayed any time on the display unit 112.

Also, in this embodiment, a change or modification of an image in the album is made on the transmission side apparatus can be easily reflected on an album stored in the reception side apparatus.

It is therefore very easy to shape the same album by the apparatus on transmission and reception sides.

Furthermore, the method of transmitting the transmission information can be realized by making a computer execute the software programs realizing the method, the software programs being stored in a storage medium.

Many modifications and variations of the present invention are possible in the light of the above techniques. It is, therefore, to be understood that within the scope of the invention the invention may be practiced otherwise than as specifically described.

What is claimed is:

1. An image storing apparatus comprising:
receiving means for receiving information including image data and the management information of the image data,
storing means for storing the image data and the management information of the image data,
display means for displaying the image data on a basis of the management information of the image data in each groups,
detecting means for detecting the image data and the management information of the image data in the received information by said receiving means, and
control means for controlling said display means to display the image data on a basis of the management information of the image data when said detecting means detects both the image data and the management information of the image data in the information received by said receiving means.

2. An image storing apparatus according to claim 1, wherein the management information includes character data which is displayed on said display means.

3. An image storing apparatus according to claim 1, the apparatus further comprising;
first transmitting means for transmitting the image data and the management information of the image data in said storing means, and
setting means for setting time of transmitting the image data and/or the management information of the image data, wherein
said control means controls said first transmitting means to transmit the image data and/or the management information of the image data at the set time.

4. An image storing apparatus according to claim 1, wherein the management information stored in said storing means is displayed on said display means.

5. An image storing apparatus comprising;
receiving means for receiving information including image data and the management information of the image data,
storing means for storing the image data and the management information thereof in the received information by said received portion,
display means for displaying a plurality of image data in each groups on a basis of the management information,
detecting means for detecting the image data and the management information thereof in the information received by said receiving means, and
control means for controlling said display means to display, when said detecting means detects only the image data in the information received by said receiving means, the received image data in a new group.

6. An image storing apparatus according to claim 5, further comprising
group setting means for controlling said display means to display, when said detecting means detects only the image data whose volume is over a predetermined value thereof, the image data so as to be divided into a plurality of new groups.

7. An image storing apparatus according to claim 5, further comprising;
second transmitting means for transmitting the image data and the management information of the image data in said storing means, and
time setting means for setting time of transmitting the image data and/or the management of the image data, whereby said control means controls said second transmitting means to transmit the image data and/or the management information of the image data at the set time.

8. An image storing apparatus according to claim 5, wherein the management information stored in said storing means is displayed on said display means.

9. An image transfer system comprising;
a transmitting apparatus and a receiving apparatus,
said transmitting apparatus including;
first storing means for storing an image file including a plurality of image data,
second storing means for storing management information of the image data,
first changing means for changing in connection with the image data stored in said first storing means,
first revising means for revising the management information stored in said second storing means on a basis of the change of the image data by said first changing means,
first generating means for generating transfer information on a basis of the management information changed by said changing means, and
first transmitting means for transmitting the transfer information generated by said generating means through a telephone line,
said receiving apparatus including;
third storing means for storing an image files including a plurality of image data,
fourth storing means for storing the management information in connection with the image data in the image file,
second receiving means for receiving the transfer information from said first transmitting means of said transmitting apparatus through a telephone line,
second changing means for changing in connection with the image file stored in said third stored means,
second revising means for revising the management information stored in said fourth stored means, and
control means for, when said second receiving means receives the transmitting information from the first transmitting means, controlling said second changing means and said second revising means to be operated automatically on a basis of the transmitting information thus received.

10. An image transfer system according to claim 9, wherein the transfer information includes the image file and the management information thereof.

11. An image transfer system according to claim 9, wherein said transmitting apparatus further includes time setting means for setting time to transmit the transfer information, whereby said control means controls said first transmitting means to transmit the transfer information at the set time by said time set mean.

12. An image transfer system according to claim 9, wherein said transmitting apparatus further includes display means for displaying the image file in said first storing means and/or the management information in said second storing means.

13. An image transfer system according to claim 9, wherein said transmitting apparatus further includes display means for displaying the transfer information generated by said first generating means.

14. An image transfer system comprising;
a transmitting apparatus and a receiving apparatus,
said transmitting apparatus including;
first storing means for storing an image file including a plurality of image data,
second storing means for storing management information of the image data,
first changing means for changing in connection with the image data stored in said first storing means,
first revising means for revising the management information stored in said second storing means on a basis of the change of the image data by said first changing means,
first generating means for generating first transfer information on a basis of the management information changed by said changing means, and
first transmitting means for transmitting the first transfer information generated by said generating means through a telephone line.
said receiving apparatus including;
third storing means for storing an image files including a plurality of image data,
fourth storing means for storing the management information in connection with the image data in the image file,
second receiving means for receiving the first transfer information from said first transmitting means of said transmitting apparatus through a telephone line,
second changing means for changing in connection with the image file stored in said third stored means,
second revising means for revising the management information stored in said fourth stored means,
comparing means, when said first receiving means of said receiving apparatus receives only the management information from said first transmitting means of said transmitting apparatus, for comparing the management information in said fourth storing means and the management information transmitted by said first transmitting means of said transmitting apparatus,
second generating means for generating second transfer information based on a result of comparison of said comparing means, and
second transmitting means for transmitting the second transmitting information to said transmitting apparatus.

15. An image transfer system according to claim 14, wherein the second transmitting information includes the result of the comparison of said comparing means.

16. An image transfer system according to claim 14, wherein the second transfer information includes information about a request for transmitting the image data is not stored said third storing means.

17. An image transfer system according to claim 14, wherein said transmitting apparatus further includes display means for displaying the image file in said first storing means and/or the management information in said second storing means.

18. An image transfer system according to claim 14, wherein, when said first receiving means for said transmitting apparatus receives the second transfer information transmitted by said second transmitting means, said first transmitting means transfers the image data stored in said first storing means to said second receiving means of said receiving apparatus.

19. An image transfer system according to claim 14, wherein said transmitting apparatus further includes display means for displaying the second transfer information transmitted by said second transmitting means of said receiving apparatus.

20. In an image transfer system comprising;
a transmitting apparatus and a receiving apparatus,
said transmitting apparatus including;
first storing means for storing an image file including a plurality of image data,
second storing means for storing management information of the image data,
first changing means for changing in connection with the image data stored in said first storing means,
first revising means for revising the management information stored in said second storing means on a basis of the change of the image data by said first changing means,
first generating means for generating first transfer information on a basis of the management information changed by said changing means, and
first transmitting means for transmitting the first transfer information generated by said generating means through a telephone line.
said receiving apparatus including;
third storing means for storing an image files including a plurality of image data,
fourth storing means for storing the management information in connection with the image data in the image file,
second receiving means for receiving the first transfer information from said first transmitting means of said transmitting apparatus through a telephone line,
second changing means for changing in connection with the image file stored in said third stored means, and
second revising means for revising the management information stored in said fourth stored means,
a method of transmitting image data comprising;
step for transmitting the management information stored in said second stored by said first transmitting means of said transmitting apparatus,
step for comparing, when said first receiving means of said receiving apparatus receives the management information, the received management information and the management information stored in said fourth storing mean,
step for generating the second transfer information on a basis of the result of comparing of both of information, and
step for transmitting the second transfer information.

21. A method of transmitting image data according to claim 20, wherein the second transmitting information includes the result of comparing by said comparing mean.

22. A method of transmitting image data according to claim 20, wherein the second transmitting information includes information about a request for transmitting the image data which is not stored in said third storing mean.
